(19) United States
(12) Patent Application Publication
(10) Pub. No.: US 2020/0128287 A1
(43) Pub. Date: Apr. 23, 2020

(54) CAPTURED CONTENT SHARING INTERFACE

(71) Applicant: Uzi MAIMON, Bat Yam (IL)

(72) Inventor: Uzi MAIMON, Bat Yam (IL)

(21) Appl. No.: 16/626,491

(22) PCT Filed: Jun. 22, 2018
(86) PCT No.: PCT/IL2018/050699

§ 371 Date: Dec. 24, 2019

Related U.S. Application Data
(60) Provisional application No. 62/524,909, filed on Jun. 26, 2017.

(51) Int. Cl. H04N 21/2743; H04N 21/472; G06F 16/955; G06F 16/9538; G06F 16/44

(52) U.S. Cl. CPC H04N 21/2743; H04N 21/47202; G06F 16/44; G06F 16/955; G06F 16/9538; H04N 21/47205

(57) ABSTRACT

Methods and systems are provided for enhanced content sharing between a first computing device and a second computing device, including identifying a content capture trigger associated with the first computing device; responsively recording captured content and one or more state parameters defining a state of the application; and transmitting data comprising the captured content and the one or more state parameters to a second computing device, wherein the second computing device is configured to present the captured content in a dynamic form providing an indication of the state of the application at the time of the content capture trigger.

### FIELD OF THE INVENTION

The present invention relates to screen capture in general, and in particular to methods and systems for sharing content and application states between computing devices.

### BACKGROUND OF THE INVENTION

Software applications designed for computing devices, often referred to as “apps”, enable interaction between people through the sharing of content, such as text messages, photos, video clips, web links, or geographic coordinates. To improve security and reliability, an operating system (OS) on a computing device (e.g., a smartphone, tablet, notebook computer, computer desktop, or smart TV) generally runs an app within a “sandbox”, that is, within a controlled environment whereby all communications with other apps and device I/O are mediated by the OS. Apps in this sense of the term generally do not have direct means of communicating with other apps or with device I/O and memory.

Methods for sharing content are described in the following publications, incorporated herein by reference. U.S. Patent Application 2016/0306801 to Andrianakou, et al., describes a method for performing a search for “deep links” in native apps, that is, pages within a native app other than the default home page. U.S. Patent Application 2015/0156061 to Saxena, et al., describes a system in which a server responds to a user's information needs by mapping those needs to deep links of available apps. U.S. Patent Application 2015/0128017 to Fithian, et al., describes mapping hypertext to screenshots in a collaborative environment. U.S. Patent Application 2014/0156599 to Quan, et al., describes a process for saving application state data. U.S. Pat. No. 9,311,168 to Lewis, et al., describes a system with a deep link generator that generates and stores deep links in a metadata database that is searchable by a web search engine.

### SUMMARY

The present invention provides methods and computer products for implementing a framework for sharing content between computing devices, and more particularly, sharing content captured by one device and replicating it on a second device.

According to embodiments of the present invention, a method is provided for content sharing between a first computing device and a second computing device, the method including configuring an application, having machine code executable on a computer processor of the first computing device, to perform the steps of:

identifying a content capture trigger associated with the first computing device; responsively recording captured content and one or more state parameters defining a state of the application; and transmitting data comprising the captured content and the one or more state parameters to a second computing device, wherein the second computing device is configured to present the captured content in a dynamic form providing an indication of the state of the application at the time of the content capture trigger.

According to further embodiments, the application is a first application and the state parameters enable a second application, executed on the second computing device, to simulate the state of the first application at the time of the content capture trigger.

According to further embodiments, the first and second applications are first and second copies of a single application. Identifying the content capture trigger may include identifying one or more user inputs entered by at least one of a keyboard, a mouse, a device button, a touchscreen and a screen image button. Identifying the content capture trigger may alternatively or additionally include identifying a screenshot trigger performed by a user of the first computing device. Identifying the content capture trigger may alternatively or additionally include identifying a predefined event occurring during operation of the first computing device.

Transmitting the data to the second computing device may include transmitting the data to a share-enabling server, and may further include configuring the share-enabling server to generate a Uniform Resource Location (URL) link and configuring the application to receive the URL link and to transmit the URL link to the second computing device. The dynamic form of presentation may be a dynamic web page, and the method may also include configuring the share-enabling server to perform the steps of responsively to receiving the data, generating code for creating the dynamic web page including the data generating the URL link addressing the code, transmitting the URL to the application running on the first computing device, receiving the corresponding request for the URL from the second computing device; and delivering the dynamic web page to the second computing device.

In further embodiments, the method further comprises configuring the share-enabling server to perform the steps of: receiving, with the corresponding request for the URL from the second computing device, identifying parameters of the second computing device; subsequently receiving from the second computing device a request for the state parameters; and responsively transmitting the state parameters to the second computing device. The application may be a first application and the dynamic web page may include a deep link specifying execution of a second application and including the state parameters.

There is also provided, in accordance with further embodiments of the present invention, a computer product for enhanced content sharing by a first computing device, the computer product including an application, having machine code that is configured to run on a processor of the first computing device, to perform the steps of: identifying a content capture trigger associated with the first computing device; responsively recording captured content and one or more state parameters defining a state of the application; and transmitting data comprising the captured content and the one or more state parameters to a second computing device, wherein the second computing device is configured to present the captured content in a dynamic form providing an indication of the state of the application at the time of the content capture trigger.

Other features and advantages of the invention will be apparent from the following detailed description, and from the claims.

### BRIEF DESCRIPTION OF THE DRAWINGS

The foregoing will be apparent from the following more particular description of exemplary embodiments of the invention, wherein

FIG. 1 is a diagram schematically illustrating a system for sharing content between computing devices, in accordance with some embodiments of the present invention;

FIG. 2 is a flow diagram schematically illustrating a content capture and sharing process implemented by a share-enabled app running on a sending computing device, in accordance with some embodiments of the present invention;

FIG. 3 is a flow diagram schematically illustrating a content capture and sharing process implemented on a receiving computing device, in accordance with some embodiments of the present invention;

FIG. 4 is a flow diagram schematically illustrating a process performed by a share-enabling server, in accordance with some embodiments of the present invention; and

FIG. 5 is a flow diagram schematically illustrating a process for configuring the share-enabled app and the share-enabling server, in accordance with some embodiments of the present invention.

### DETAILED DESCRIPTION

While the description below covers several embodiments of the present invention, these should not be construed as limitations on the scope of the invention, but rather as exemplifications. Those skilled in the art will envision other possible variations that are within the scope of the invention.

Embodiments of the present invention provide methods and systems enabling content of apps to be shared between users, in particular content captured at specific moments of app operation. The methods and systems also provide a software development kit for implementing share-enabled apps. The methods and systems also provide means for motivating new users to install apps promoted by friends, thereby benefitting users, as well as the “app owner” or app developer, who generally have a commercial interest in increasing the number of installed users. The methods and systems also provide means for disseminating commercial advertisements to users.

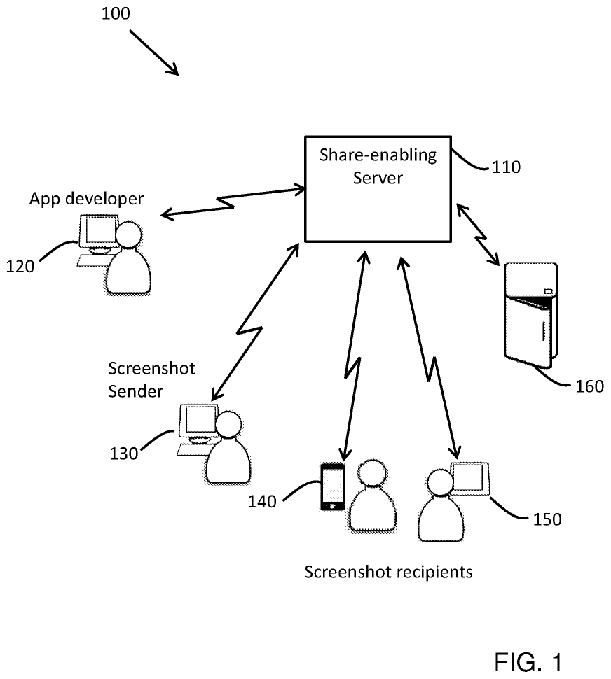

FIG. 1 is a diagram schematically illustrating a system 100 for sharing content between users of computing devices, in accordance with some embodiments of the present invention. A computer server 110, having internet access and high availability, is configured as a share-enabling server (“the server”) to perform the functions described hereinbelow. These functions include services supporting operation of a software development kit (SDK) used by an app developer operating a development station 120. Server functions may also include operations to support content sharing between devices, such as devices indicated as 130, 140, 150 and 160. Such devices may be mobile devices, such as a smartphone 140 and a tablet 150, and/or non-mobile devices, such as a computing desktop 130 or smart TVs. Devices may also be smart appliances, for example, an app-enabled kitchen appliance, such as a smart refrigerator 160 (a refrigerator with a processor and memory able to perform computing functions) or similar Internet of Things (“TOT”) devices.

In embodiments of the present invention, the app developer uses the SDK to develop a “share-enabled” app of the invention, which may run on any or all of the different device platforms and/or different OS's. An app may run on different platforms and OS's with almost identical user interfaces and operating logic, but different machine level instruction code.

The share-enabled app may be supplied pre-installed on a device, or the user may download and install the app to his device, for example from app repositories, such as the Google Play™ store, the Apple App Store® and the Samsung Galaxy Apps™. Apps may include, by way of example, smartphone apps, PC apps and smart appliance apps.

Subsequently, the user, while interactively operating the device, may provide input that triggers the capturing of content related to a state of the app. The app is generally configured to allow the user to trigger the content capture at an arbitrary point in time. In addition, the app may be configured such that the user may define events at which time the triggering occurs automatically. For example, the app may be configured such that the user may specify a triggering at event occurring in a game, such as when the user fires at an opponent (during a shooter type of game).

The content captured in response to the trigger may include a screenshot, that is, an image of the screen that is recorded as a bit map image or a compressed image in a format such as jpeg or any other imaging format. Alternatively, the application may be configured to record other content related to the operation of the app at the time of the content capture trigger, such as a sequence of images, in formats such as animated GIF, or a video clip, or a music clip, or a combination of several types of media. The share-enabled app may also be configured to capture data related to the device and the device status, such as error codes or sensor readings from the device hardware or firmware.

In addition to capturing content at the time of the content capture trigger, the app may also record state parameters defining the state of the app, such that the state of the app may be subsequently replicated by an (equivalent, similar or identical) app executed on a recipient's device. Hereinbelow, the state of the app at the time of the content capture is referred to as the “captured state”.

The share-enabled app may be configured such that after content has been captured, a message with the captured content may be sent to a device of a second user, that is, a recipient. The recipient can then act upon the message. Actions by the recipient in response to the message may include accessing a dynamic webpage that presents the captured content in a manner that simulates the state of the sending device when the content capture was triggered. Recipients may also decide, after receiving the sender message, whether or not to run the app on their own devices. The app may be configured to enable (when operated on a recipient's device) “deep linking”, such that when executed, with the parameters defining the app state, the app can replicate that state, or closely replicate the state within limitations imposed by the differences between the sender and recipient devices.

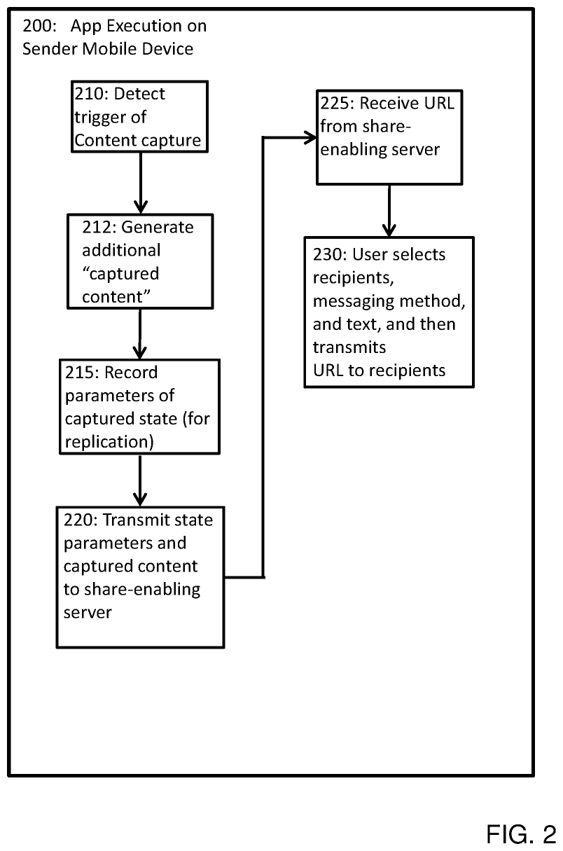

FIG. 2 is a flow diagram schematically illustrating a process implemented by a share-enabled app 200, in accordance with some embodiments of the present invention. As described above with respect to FIG. 1, a sending user operating any of computing devices 130-160 may have a share-enabled app on his device.

At a step 210, the user, at any arbitrary point in time in the course of running the app, may trigger a content capture. Alternatively, the app may trigger the content capture at a predefined time or upon the occurrence of a predefined event during operation of the app.

The user may initiate an impromptu triggering of the content capture by means of a screenshot trigger, which many devices are configured to perform when the user presses a default screenshot capture button (or combination of buttons). The action may be detected by the OS, often without providing a mechanism for directly notifying the app. Apps generally cannot interfere with the default screenshot mechanism. An advantage of using the screenshot trigger to trigger content capture is that users of a device are often familiar with the mechanism for generating a screenshot, and may be less familiar with features of a particular app. Alternatively, or additionally, the app may be configured such that the user may trigger the content capture by entering an input, or a sequence of inputs, through means that are transmitted by the OS directly to the app, such as most keyboard, touch screen, or mouse inputs. Alternatively, the app may provide a screen image button, which, when manipulated (clicked, pressed etc.) by the user, triggers the content capture.

The app may operate as described above in a sandbox of the OS, without access to the device input for creating a screenshot. Consequently, in order for the screenshot to trigger the state capture, the app may be configured to sense the screenshot action. In some embodiments of the present invention, the app is configured to monitor the area of device storage allocated for screenshots. That is, the app is configured to have access to certain areas of the device file storage, including the file storage to which screenshots are saved.

If the trigger is a screen capture, the screen capture image is available to the app in the file storage area described above. At a step 212, after the content capture is triggered, the app captures additional content related to the state of the app, such as audio and video clips, or any other data that may facilitate emulating the app, at the time of the trigger, in a dynamic web page, as described further hereinbelow. The captured content may include sufficient animation or video to show a brief moment of action, such as an object being hit. Captured content may also include additional information such as game statistics and game data parameters (current score, current game location and other game data parameters relevant to the current state). If the app is a shopping app, the captured content may include interactive elements for viewing sale products in more detail, the senders' purchasing data as he fed it before creating the screenshot, and additional information as a comparative data. If the app is a music player app, the captured content may include an audio segment of a few seconds, as well as some details about the content creation, such as the creator name and time of creation.

Next, at a step 215, the app may record state parameters defining the state of the app, including all data necessary for subsequently replicating the captured state when the app is running on another device. Such data may include, for example, an index number identifying a scene of a game, as well as objects in the scene, 3D coordinates, and orientations. The data may also include settings of an operating mode (for example, when the device is a smart appliance), or identifiers of items being presented in a shopping application.

At a step 220, the app may transmit a message with the state parameters and the captured content to a share-enabling server. The server is typically located remotely from the sending device, such that communications between the server and the device are implemented by internet protocols. These may include secure protocols, such as https. The app is typically pre-configured with an appropriate internet address of the server.

As described further hereinbelow, the server receives and stores the captured content and the state parameters. In some embodiments, the server may then generate a unique Uniform Resource Location (“URL”) link, which, when accessed, returns Hypertext Markup Language (HTML) code. The HTML code may include links to the captured content and state parameters as stored on the server. Alternatively or additionally, the HTML code may include links to copies of the share-enabled app that a recipient may run or download, as described further hereinbelow. The HTML code may also be configured to present the captured content as a dynamic webpage, in a form that simulates the audio and video appearance of the app at the moment the content was captured.

At a step 225, the server sends a response to the app running on the sender's device, including the URL link in the response.

In typical embodiments, steps 210 through 225 of process 200 are performed by the app in a background mode of operation, such that the user is unaware of the process being performed. At step 230, the app may present to the user a “share” option, which is typically provided by a messaging feature of the OS. The share option presents the user with options for sending a message to a recipient, the message being the URL link generated by the server. Utilizing the share option, the user may select a desired messaging app, and may also select recipients. The message may be sent by messaging apps installed on the device, which may be proprietary apps, such as Whatsapp™, or apps implementing open protocols, such as internet “mail” delivery systems.

Depending on the messaging method, the user may also add text explaining the purpose of the link being delivered, and may add a representation of the captured content such as the screenshot. In a further embodiment, the app is configured with a predefined recipient address, and a message with the URL from the server is delivered automatically.

In further embodiments, the app may be configured to delay step 230 until a time that the user determines. For example, when the app is a game, the user may not want to pause the game at the moment of the content capture. Instead, the user may want to take capture content at multiple points during the course of the game, and may then view and/or listen to a listing of multiple content capture points at a more convenient moment of the app operation. Upon displaying the listing of content capture contents, the user may then choose the app states that he wants to share, and then implement the sharing process. The app thus enables the user to recall the moments of the game that might interest his recipients. In still further embodiments, the app may be configured to automate step 230, whereby a recipient list and messaging method are pre-defined, that is, defined by the user, or set in the app by default, before the content capture is triggered.

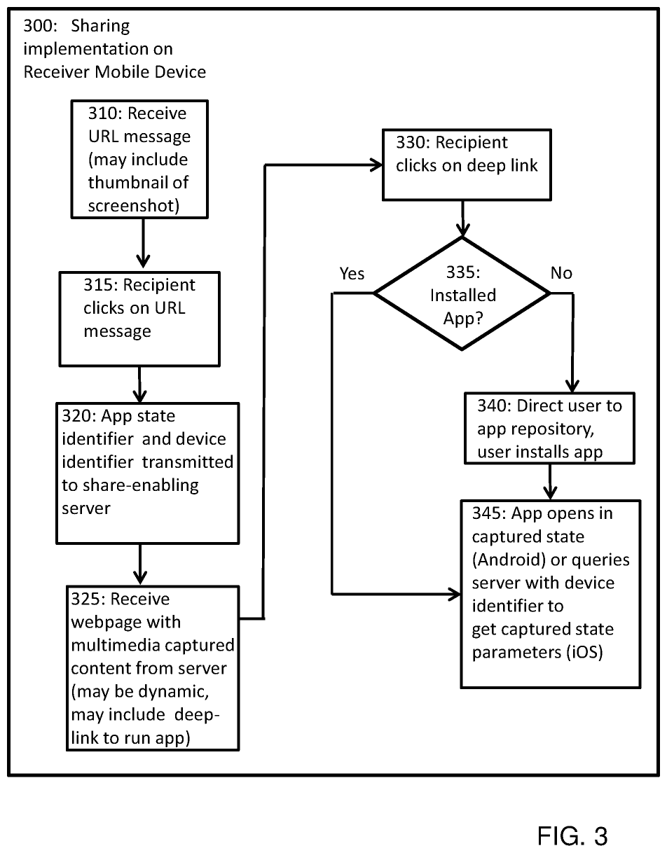

FIG. 3 is a flow diagram schematically illustrating a captured content sharing process 300 implemented by the recipient user's computing device, in accordance with some embodiments of the present invention.

At a step 310, the recipient receives the message sent by the sending user, including the URL link as described above.

Typical messaging apps on consumer computing devices are configured such that a URL text message is converted to a hyperlink that may be tapped or clicked by the user. At a step 315, the user performs the appropriate hyperlink action, causing a request for the url content (typically a web page) to be delivered from the recipient device to the server at a step 320. The request from the recipient device will generally include identifying information regarding the type of the requesting device and OS, which may be, for example, an OS such as Android™ or iOS™.

Upon receiving the server response, at a step 325 the messaging app may open a web browser and download a web page (i.e., HTML code) provided by the server. The server is generally configured to provide a web page appropriate for the receiving user's type of device. The web page from the server may include captured content, including audio and video, which may be presented in a dynamic form determined by a template described further hereinbelow. The dynamic presentation of the captured multimedia content emulates the “look and feel” of the app at that time, that is, the dynamic presentation provides an indication of the state of the application at the time of the content capture trigger. One advantage of emulating the app at the time of content capture is that the user can gain a sense of the app experience, which is a means of promoting the app and encouraging the user to download it. In addition, the web page may include commercial information such as advertisements, or commercial videos.

The web page provided by the server may also include a “deep link” that is, a form of hyperlink to a version (i.e., copy) of the share-enabled app. The syntax of the hyperlink is configured for the user's type of device. The deep link generally includes the state parameters captured by the app on the sender's device. For Android, which supports automatic “deferred deep linking”, the deep link URL includes the parameters, which the OS saves in order to pass to the app, once installed. For other OS's, such as iOS, the app, once installed and executed, is configured to check the server to determine whether the app was installed followed receipt of the captured content. The server then compares the identifying information of the device with previously acquired information, and, if there is a match, provides the parameters necessary for enabling the app to perform a deferred deep link.

The “deep link” web page provided by the server includes the captured content promoting the app, and the recipient may respond by proceeding to execute or to download the app by either clicking or otherwise invoking the “deep link”, at a step 330. At a step 335, the OS of the recipient device determines if the app is installed or not. If the app is already installed on the recipient's device, clicking on the deep link causes the app to open, at a step 345, at the state of the share-enabled app, thereby replicating the state of the share-enabled app at the time that the content was captured.

If the share-enabled app is not installed on the device, invoking the deep link causes the OS, at a step 340, to issue a request to a default app repository (e.g., Google Play Store or Apple App Store or Samsung App Store), from which the app may be downloaded by the recipient. Subsequently, at step 345, the OS implements a “deferred deep linking” process, to open the app at the desired state, as described above.

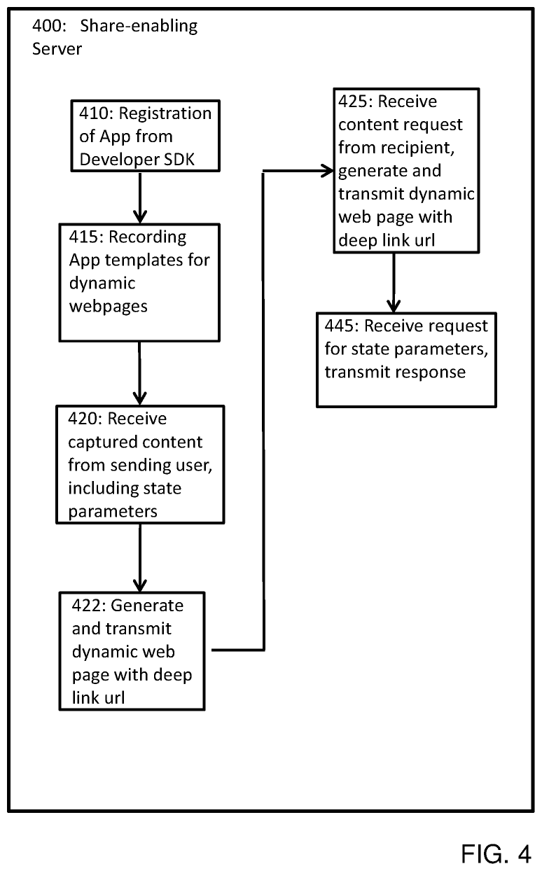

FIG. 4 is a flow diagram schematically illustrating a process 400 performed by the share-enabling server, in accordance with some embodiments of the present invention. The share-enabling server typically includes several server technologies, including a web server, a database, and application specific software configured to implement the functions described above.

Initially, an app developer may operate a Software Development Kit (SDK) to integrate into an app the share-enabled features described above with respect to FIGS. 2 and 3. At a step 410, the app developer also registers the app with the server, such that the server is configured to respond to subsequent messages from the share-enabled app.

At a step 415, the app developer may provide the server with templates for coding the dynamic webpage described above with respect to FIG. 3. Dynamic webpages generally are in the form of a dynamic HTML template, which is prepared during app development by the developer and uploaded to the server from the SDK.

After the share-enabled app is ready for distribution and registered with the server, the first user, i.e., the “sending user”, downloads and installs the app if it is not previously installed. Subsequently, the user performs the content capture as described above with respect to FIG. 2. The share-enabled app then messages the server at a step 420, which is the complement of the sending step of the app, described above with respect to step 220 of FIG. 2. The message sent by the share-enabled app may include the captured content and the state parameters.

At a step 422, the server responds to the initial message from the screenshot sender by storing the captured content and state parameters and by generating the appropriate URL link, which is return to the screenshot sender.

At a step 425, the screenshot recipient has received the dynamic webpage with the app link (step 325) and has requested to continue with the process (step 330). As noted above, the current implementation of the Android OS enables users to download an app and execute it with a deep link, without further server input. If an OS is not configured in this manner, the app, upon initial execution, may be configured to query the server at a step 445 (the complement of recipient step 345) in order to determine if the app is running following receipt of captured content, and if so, to receive the state parameters necessary for executing at a deep link state.

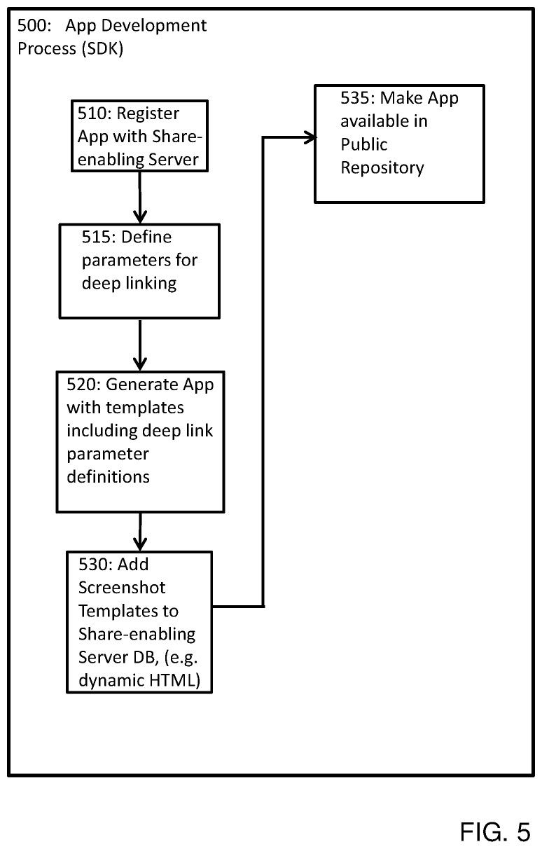

FIG. 5 is a flow diagram schematically illustrating a process 500 by which an app developer may configure a share-enabled app and a share-enabling server, in accordance with some embodiments of the present invention. Process 500 is typically implemented by a software development kit (SDK) operated by an app developer in order to provide a given app, such as a game app or shopping app or music app, with features of the share-enabled app described above.

At an initial step 510, the developer operates the SDK and registers the app with the server. Next, at a step 515, the developer defines the state (i.e., “deep link”) parameters that will be stored when content capture is triggered, as well as the content that will be captured to enable dynamic web page emulation.

At a step 520, the developer generates the app with the code necessary for generating the captured content and state parameters as described above. The developer also may include parameters that are added to the HTML templates for creating dynamic web pages, as described above. Subsequently, at a step 530, the developer may add the HTML templates to the server, to enable the server to send dynamic webpages to recipients. In some embodiments, communication of the templates to the server is performed by the SDK.

Finally, at a step 535, the app and server having been configured to implement the methods and systems of sharing captured content, the app developer makes the app available in one or more app repositories for downloading by users.

All or part of the processes and system described above can be implemented as computing systems in digital electronic circuitry, or in computer hardware, firmware, software, or in combinations thereof. Applications are generally programmed in a high-level language, which is subsequently compiled into machine executable code. The computing systems may have one or more processors and one or more network interface modules. Processors may be configured as multi-processing or distributed processing systems. Means of communications may include network interface modules that control the sending and receiving of signals that may represent data packets. Security modules may be implemented to control access to all data and modules. All or part of the systems and processes can be implemented as computer program products, tangibly embodied in an information carrier, such as a machine-readable storage device or in a propagated signal, for execution by, or to control the operation of, data processing apparatus, such as a programmable processor, computer, or deployed to be executed on multiple computers at one site or distributed across multiple sites. Memory storage may also include multiple distributed memory units, including one or more types of storage media.

Method steps associated with the system and process can be rearranged and/or one or more such steps can be omitted to achieve the same, or similar, results to those described herein. It is to be understood that the embodiments described hereinabove are cited by way of example, and that the present invention is not limited to what has been particularly shown and described hereinabove. Rather, the scope of the present invention includes variations and modifications thereof which would occur to persons skilled in the art upon reading the foregoing description and which are not disclosed in the prior art.

Other embodiments not specifically described herein are also within the scope of the following claims. While this invention has been particularly shown and described with references to most preferred embodiments thereof, it will be understood by those skilled in the art that various changes in form and details may be made therein without departing from the scope of the invention encompassed by the appended claims.

1-20. (canceled)

21. A method for enhanced content sharing between a first computing device and a second computing device, the method comprising:
executing, at the first computing device, an interactive application, comprising machine code executable on a computer processor of the first computing device, to perform steps of:
identifying triggering of a content capture trigger associated with the first computing device;
responsively recording captured content and one or more state parameters, wherein captured content is multimedia content that is indicative of a state of the interactive application at the time of the triggering, and the state parameters are parameters that enable the interactive application, when executed on the second computing device, to replicate the state of the interactive application at the time of the triggering on the first computing device;
transmitting share data comprising the captured content and the one or more state parameters to a share-enabled server;
receiving a first Uniform Resource Location (URL) link from the share-enabled server;
transmitting the first URL link to the second computing device through a messaging service supporting opening of the first URL link in a web browser on the second computing device;
and
executing, at the share-enabled server, a server application comprising machine code executable on a computer processor of the share-enabled server, to perform steps of:
receiving the share data from the interactive application on the first computing device;
generating the first URL link and transmitting the first URL link to the interactive application on the first computing device;
receiving a web query according to the first URL link from the web browser on the second computing device; and
responsively transmitting to the second computing device a web page to present in the web browser, wherein the web page includes, according to specifications of a dynamic HTML template created for the interactive application, a dynamic presentation of the captured content and a hyperlink to a second URL, wherein the second URL is a deep link for execution of the interactive application on the second computing device and includes the one or more state parameters, such that clicking on the hyperlink executes, on the second computing device, the interactive application in the state of the interactive application at the time of the triggering.

22. The method of claim 21, wherein identifying triggering of the content capture trigger comprises identifying one or more user inputs entered by at least one of a keyboard, a mouse, a device button, a touchscreen and a screen image button.

23. The method of claim 21, wherein identifying triggering of the content capture trigger comprises identifying a screenshot trigger performed by a user of the first computing device.

24. The method of claim 21, wherein identifying triggering of the content capture trigger comprises identifying a predefined event occurring during operation of the first computing device.

25. The method of claim 21, further comprising performing, at the share-enabling server, the steps of:
receiving, with the web query from the web browser on the second computing device, identifying parameters of the second computing device;
subsequently receiving from the second computing device a request for the state parameters; and
responsively transmitting the state parameters to the second computing device to implement deferred deep linking on the second computing device.

26. The method of claim 21, wherein clicking on the hyperlink opens a download page for downloading the second interactive application from an app repository.

27. The method of claim 21, wherein the web page further includes an advertisement promoting the second interactive application.

28. A system for enhanced content sharing between a first computing device and a second computing device, the system comprising:
the first computing device, comprising a processor and a memory having an interactive application, the interactive application comprising machine code executable on the processor to perform steps of:
identifying triggering of a content capture trigger associated with the first computing device;
responsively recording captured content and one or more state parameters, wherein captured content is multimedia content that is indicative of a state of the interactive application at the time of the triggering, and the state parameters are parameters that enable the interactive application, when executed on the second computing device, to replicate the state of the interactive application at the time of the triggering on the first computing device;
transmitting share data comprising the captured content and the one or more state parameters to a share-enabled server;
receiving a first Uniform Resource Location (URL) link from the share-enabled server;
transmitting the first URL link to the second computing device through a messaging service supporting opening of the first URL link in a web browser on the second computing device;
and
a share-enabled server, comprising a processor and a memory having a server application, the server application comprising machine code executable on the processor to perform steps of:
receiving the share data from the interactive application on the first computing device;
generating the first URL link and transmitting the first URL link to the interactive application on the first computing device;
receiving a web query according to the first URL link from the web browser on the second computing device; and
responsively transmitting to the second computing device a web page to present in the web browser, wherein the web page includes, according to specifications of a dynamic HTML template created for the interactive application, a dynamic presentation of the captured content and a hyperlink to a second URL, wherein the second URL is a deep link for execution of the interactive application on the second computing device and includes the one or more state parameters, such that clicking on the hyperlink executes, on the second computing device, the interactive application in the state of the interactive application at the time of the triggering.

29. The system of claim 28, wherein identifying the content capture trigger comprises identifying one or more user inputs entered by at least one of a keyboard, a mouse, a device button, a touchscreen and a screen image button.

30. The system of claim 28, wherein identifying the content capture trigger comprises identifying a screenshot trigger performed by a user of the first computing device.

31. The system of claim 28, wherein identifying the content capture trigger comprises identifying a predefined event occurring during operation of the first computing device.

32. The system of claim 28, wherein the share-enabling server is further configured to perform the steps of:
receiving, with the web query from the web browser on the second computing device, identifying parameters of the second computing device;
subsequently receiving from the second computing device a request for the state parameters; and
responsively transmitting the state parameters to the second computing device to implement deferred deep linking on the second computing device.

33. The system of claim 28, wherein clicking on the hyperlink opens a download page for downloading the second interactive application from an app repository.

34. The system of claim 28, wherein the web page further includes an advertisement promoting the second interactive application.
